(19) United States
(12) Patent Application Publication
(10) Pub. No.: US 2019/0257398 A1
(43) Pub. Date: Aug. 22, 2019

(54) VIBRATION DAMPING DEVICE

(71) Applicant: AISIN AW CO., LTD., Anjo-shi, Aichi-ken (JP)

(72) Inventors: Kazuyoshi ITO, Tsushima (JP); Yoichi OI, Ama (JP); Masaki WAJIMA, Nagoya (JP); Hiroki NAGAI, Anjo (JP); Takao SAKAMOTO, Anjo (JP)

(73) Assignee: AISIN AW CO., LTD., Anjo-shi, Aichi-ken (JP)

(21) Appl. No.: 16/312,353

(22) PCT Filed: Sep. 8, 2017
(86) PCT No.: PCT/JP2017/032439

§ 371 Date: Dec. 21, 2018

(30) Foreign Application Priority Data
Sep. 9, 2016 (JP) 2016-176218

(51) Int. Cl. F16H 45/02; F16F 15/131; F16F 15/14

(52) U.S. Cl. CPC F16H 45/02; F16F 15/14; F16F 15/131

(57) ABSTRACT

Provided is a vibration damping device including guide surfaces that are concave surfaces formed in a support member so as to curve toward the outer periphery of the support member; mass bodies that, as the support member rotates, roll on the guide surfaces while being pressed against the guide surfaces by a centrifugal force; and inertia rings that are rotatably coupled to the mass bodies and swing about the center of rotation of the support member. When the vibration damping device is in equilibrium, the center of gravity of each mass body is located radially outward of the joint position between the mass body and the inertia rings. As the support member rotates, the inertia rings swing relative to the support member about the center of rotation of the support member, and the mass bodies roll on the guide surfaces.

### CROSS REFERENCE TO RELATED APPLICATIONS

This application is a National Stage of International Application No. PCT/JP2017/032439 filed Sep. 8, 2017, claiming priority based on Japanese Patent Application No. 2016-176218 filed Sep. 9, 2016.

### TECHNICAL FIELD

The present disclosure relates to vibration damping devices.

### RELATED ART

In some cases, constant-order dynamic dampers including a ring-shaped weight and a flyweight which are mounted on a rotary body that is driven while receiving fluctuating torque are proposed as vibration damping devices (see, e.g., Patent Document 1). This constant-order dynamic damper has a linking mechanism formed by a cam surface formed on the ring-shaped weight and a roller portion of the flyweight. As the flyweight is moved radially outward by the centrifugal force, the roller portion contacts the cam surface. The flyweight thus slides or rolls on the rotating rotary body within a predetermined range limited to the radial direction by guide grooves, and the ring-shaped weight rotates (swings) coaxially with the rotary body at least within a limited predetermined range. As a result, torque that is applied to the rotary body by swinging of the ring-shaped weight acts synchronously with fluctuation in driving torque with no delay, thereby damping vibration (fluctuation in torque) of the rotary body.

### RELATED ART DOCUMENTS

### Patent Documents

Patent Document 1: Japanese Patent Application Publication No. H01-312246 (JP H01-312246 A)

### SUMMARY OF THE APPLICATION

In the above constant-order dynamic damper, clearance needs to be provided between the flyweight and the guide grooves. When the ring-shaped weight swings, the flyweight therefore slides while being pressed against surfaces on one side of the guide grooves extending in the radial direction or slides while being pressed against surfaces on the other side of the guide grooves. Accordingly, when the surfaces of the guide grooves against which the flyweight is pressed switch between the surfaces on the one side of the guide grooves and the surfaces on the other side of the guide grooves, the flywheel becomes free and the center of gravity of the flyweight suddenly moves in the circumferential direction of the rotary body. This may adversely affect the capability of damping vibration of the rotary body.

It is one aspect of a vibration damping device of the present disclosure to improve vibration damping capability.

The vibration damping device of the present disclosure takes the following measures in order to achieve the above aspect.

The vibration damping device of the present disclosure is a vibration damping device that damps vibration of a rotary element to which torque from an engine is transmitted, including: a guide surface formed in the rotary element; a mass body that, as the rotary element rotates, rolls on the guide surface while being pressed against the guide surface by a centrifugal force; and an annular member that is rotatably coupled to the mass body and swings about a center of rotation of the rotary element, wherein when the vibration damping device is in equilibrium, a center of gravity of the mass body is located radially outward of a joint position between the mass body and the annular member.

This vibration damping device of the present disclosure includes: the guide surface formed in the rotary element to which torque from the engine is transmitted; the mass body that, as the rotary element rotates, rolls on the guide surface while being pressed against the guide surface by the centrifugal force; and the annular member that is rotatably coupled to the mass body and swings about the center of rotation of the rotary element. When the vibration damping device is in equilibrium, the center of gravity of the mass body is located radially outward of the joint position between the mass body and the annular member. Accordingly, when the rotation of the rotary element fluctuates, the annular member rotates relative to the rotary element about the center of rotation of the rotary element by the moment of inertia of the annular member, and the mass body rolls on the guide surface while being pressed against the guide surface by the centrifugal force. Each of the mass body and the annular member thus swings relative to the rotary element. At this time, the center of gravity of the mass body moves radially inward (in the radial direction or substantially in the radial direction) with respect to the position where the center of gravity of the mass body is located when the vibration damping device in equilibrium. Accordingly, (a component of) the centrifugal force acting on the mass body generates such a restoring force that returns the annular member toward the position where the annular member is located when the vibration damping device is in equilibrium. In such a device, the natural frequency of a secondary system which increases with the number of revolutions and which is determined by the mass of the mass body, the moment of inertia of the annular member, and geometric parameters for the mass body and the rotary element can be matched with the frequency of fluctuation in torque which is applied to the rotary element. As a result, vibration in antiphase from that of the rotary element is applied from the annular member and the mass body to the rotary element, whereby the vibration of the rotary element can be damped. Moreover, since the mass body rolls on the guide surface while being pressed against the guide surface by the centrifugal force, a path of the center of gravity of the mass body is continuous in the circumferential direction (the mass body does not become free and the center of gravity of the mass body therefore does not suddenly move in the circumferential direction of the rotary element). As a result, vibration damping capability of the vibration damping device is improved.

### BRIEF DESCRIPTION OF THE DRAWINGS

FIG. 1 is a schematic configuration diagram of a starting device 1 including a vibration damping device 20 of the present disclosure.

FIG. 2 is a front view of the vibration damping device 20 of the present disclosure.

FIG. 3 is a sectional view of the vibration damping device 20 of the present disclosure.

FIG. 4 is a view illustrating operation of the vibration damping device 20.

FIG. 5 is an illustration showing an example of a trajectory of the center of gravity 30g of a mass body 30.

FIG. 6 is a front view of another vibration damping device 120 of the present disclosure.

FIG. 7 is a front view of still another vibration damping device 220 of the present disclosure.

FIG. 8 is a sectional view of the still another vibration damping device 220 of the present disclosure.

FIG. 9 is a front view of a further vibration damping device 320 of the present disclosure.

FIG. 10 is a sectional view of the further vibration damping device 320 of the present disclosure.

FIG. 11 is a schematic configuration diagram showing a modification of the vibration damping device 20 of the present disclosure.

FIG. 12 is a schematic configuration diagram showing a modification of the vibration damping device 20 of the present disclosure.

### PREFERRED EMBODIMENTS

Modes for carrying out the various aspects of the present disclosure will be described below with reference to the accompanying drawings.

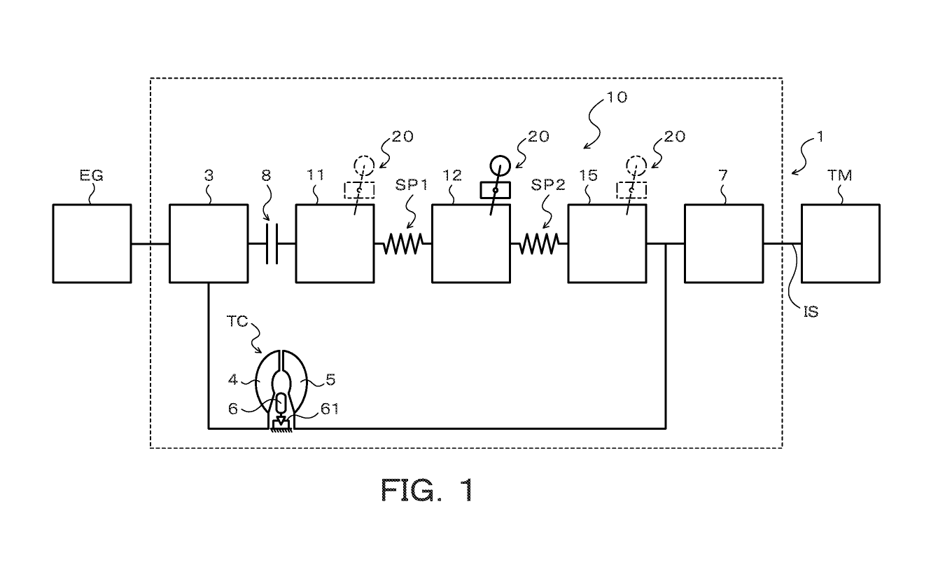

FIG. 1 is a schematic configuration diagram showing a starting device 1 including a vibration damping device 20 of the present disclosure. As shown in the figure, the starting device 1 is mounted on, e.g., a vehicle including an engine (internal combustion engine) EG serving as a drive device. The starting device 1 includes, in addition to the vibration damping device 20, a front cover 3 coupled to a crankshaft of the engine EG and serving as an input member, a torque converter (hydraulic transmission device) TC, a damper hub 7 fixed to an input shaft IS of a transmission (power transmission device) TM and serving as an output member, a lockup clutch 8, a damper device 10, etc. The torque converter TC includes a pump impeller (input-side hydraulic transmission element) 4 that is fixed to the front cover 3 and rotates with the front cover 3, a turbine runner (output-side hydraulic transmission element) 5 that can rotate coaxially with the pump impeller 4 and is fixed to a driven member 15 of the damper device 10, a stator 6 that adjusts the flow of hydraulic oil (working fluid) from the turbine runner 5 to the pump impeller 4, and a one-way clutch 61 that restricts the rotation direction of the stator 6. A configuration that does not include the stator 6 and the one-way clutch 61, that is, a configuration in which the pump impeller 4 and the turbine runner 5 function as a fluid coupling may be used instead of the torque converter TC. Examples of the transmission TM include an automatic transmission (AT), a continuously variable transmission (CVT), a dual clutch transmission (DCT), a hybrid transmission, a speed reducer, etc. The lockup clutch 8 performs a lockup operation, which is an operation of coupling the front cover 3 to the damper hub 7 via the damper device 10, and an operation of releasing the lockup coupling.

In the following description, the “axial direction” basically refers to the direction in which the central axis (axis) of the starting device 1 or the damper device 10 (vibration damping device 20) extends, unless otherwise specified. The “radial direction” basically refers to the radial direction of the starting device 1, the damper device 10, or rotary elements of the damper device 10 etc., namely the direction of a straight line extending perpendicularly (in the direction of the radius) from the central axis CA, unless otherwise specified. The “circumferential direction” basically refers to the circumferential direction of the starting device 1, the damper device 10, or the rotary elements of the damper device 10 etc., namely the direction along the rotation direction of the rotary elements, unless otherwise specified.

The damper device 10 includes, as the rotary elements, a drive member (input element) 11, an intermediate member (intermediate element) 12, and a driven member (output element) 15. The damper device 10 further includes, as torque transmission elements, a plurality of (e.g., four) first springs SP1, namely elastic bodies, which are disposed between the drive member 11 and the intermediate member 12 to transmit rotational torque (torque in the rotation direction), and a plurality of (e.g., four) second springs SP2, namely elastic bodies, which are disposed between the intermediate member 12 and the driven member 15 to transmit the rotational torque. The first and second springs SP1, SP2 are arc coil springs each made of a metal material wound so as to have an axis extending in a circular arc shape when not under load, or straight coil springs each made of a metal material wound in a helical shape so as to have an axis extending straight when not under load.

The drive member 11 is fixed to the lockup piston 8. Accordingly, when the lockup clutch 8 performs the lockup operation, the front cover 3 (engine EG) is coupled to the drive member 11. The driven member 15 is fixed to the damper hub 7 and the turbine runner 5.

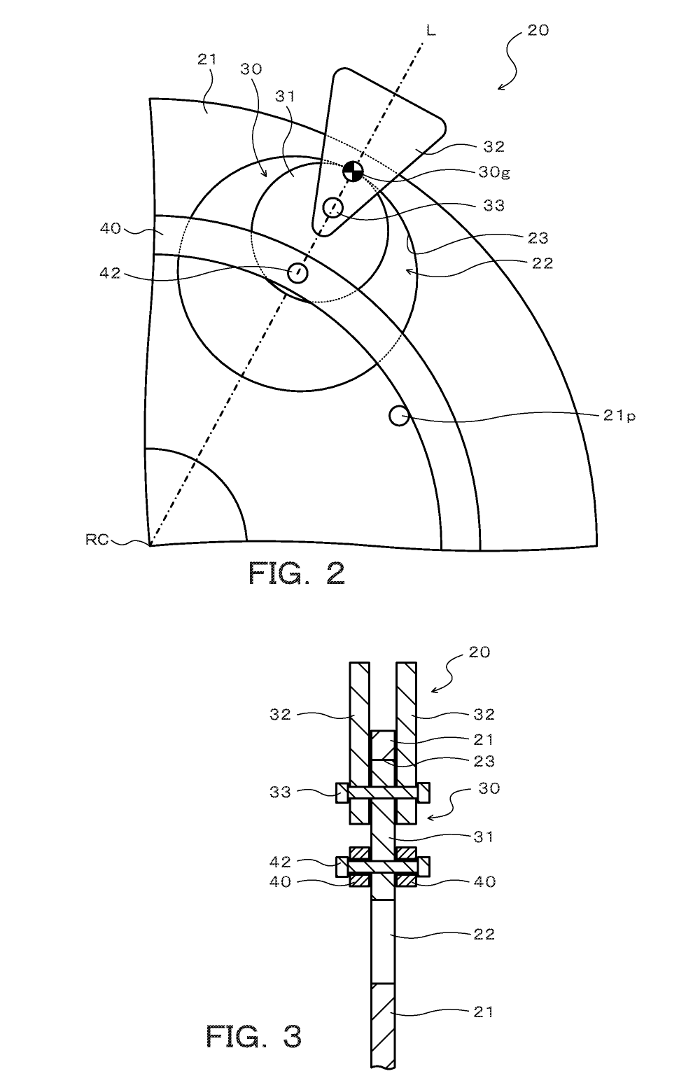

As shown in FIGS. 2 and 3, the vibration damping device 20 includes a support member 21 coaxially coupled to the intermediate member 12 of the damper device 10, a plurality of (e.g., four) mass bodies 30 each swingably supported by the support member 21, and two inertia rings 40 that are annular members each rotatably coupled to the plurality of mass bodies 30.

The support member 21 is made of a metal plate and has an annular shape. The support member 21 has a plurality of (e.g., four) guide holes 22 formed at intervals (at regular intervals) in the circumferential direction. The guide hole 22 is a circular or elliptical opening and has a concave (circular arc-shaped or elliptical arc-shaped as viewed in the axial direction) guide surface 23 that is recessed toward the outer periphery of the support member 21. The guide surface 23 is a concave circular cylindrical surface or a concave elliptical cylindrical surface, and the center of curvature of the circular arc or the elliptical arc when the guide surface 23 is viewed in the axial direction is located radially outward of the center of rotation RC. The guide hole 22 (guide surface 23) is symmetric with respect to a straight line passing through the center of rotation RC of the support member 21 and the center of the guide hole 22 as viewed in the axial direction (this straight line will be hereinafter referred to as the “reference line L”; see the alternate long and short dash line in FIG. 2).

In the illustrated example, the mass body 30 includes a center plate 31 made of a metal plate, having a circular or elliptical shape, and placed in the guide hole 22, two side plates 32 having, e.g., a triangular shape and placed on both sides of the support member 21 and the center plate 31 in the axial direction, one on each side, and a rivet 33 that fixes the two side plates 32 to side surfaces on both sides of the center plate 31 in the axial direction. However, the side plates 32 may be formed integrally with the mass body 30, and the mass body 30 need not necessarily include the rivet 33.

In the illustrated example, the outside diameter of the center plate 31 is smaller than the diameter of the guide hole 22 (the diameter of the guide hole 22 in the case where the guide hole 22 has a circular shape, and the minor axis of the guide hole 22 in the case where the guide hole 22 has an elliptical shape). The center plate 31 is coupled to the inertia rings 40 via a rivet 42 such that the center plate 31 and the inertia rings 40 can rotate relative to each other and such that, when the vibration damping device 20 is in equilibrium, the center plate 31 is symmetric with respect to the reference line L and the outermost positon of the outer peripheral surface of the center plate 31 in the radial direction contacts the guide surface 23. The center plate 31 and the inertia rings 40 thus form a turning pair. The center plate 31 and the inertia rings 40 may be coupled together via a bearing or a bush instead of the rivet 42. The center plate 31 and the two side plates 32 are coupled via the rivet 33 such that, when the vibration damping device 20 is in equilibrium, the center plate 31 and the two side plates 32 are symmetric with respect to the reference line L and the center of gravity 30g of the mass body 30 matches the outermost position of the center plate 31 in the radial direction (the contact position between the center plate 31 and the guide surface 23). The vibration damping device 20 being in equilibrium is the state where rotation of the support member 21 of the vibration damping device 20 is not fluctuating (e.g., the state where the support member 21 has stopped rotating). When the vibration damping device 20 is in equilibrium, the rivet 42 (the position of the turning pair formed by the center plate 31 and the two inertia rings 40), the rivet 33 (the joint position between the center plate 31 and the two side plates 32), and the contact position between the center plate 31 and the guide surface 23 and the center of gravity 30g of the mass body 30 are located on the reference line L in this order from the inside in the radial direction. These configurations are an example of means for defining the relative position between the center of gravity 30g and the rivet 42 (the position of the turning pair formed by the center plate 31 and the two inertia rings 40).

The two inertia rings 40 are made of a metal plate, have an annular shape, and are disposed coaxially with the support member 21 on both sides of the support member 21 in the axial direction, one on each side. The inner peripheral surfaces of the two inertia rings 40 are supported by a plurality of protrusions 21p formed at intervals in the circumferential direction on the support member 21 so as to protrude in the axial direction from the support member 21. The two inertia rings 40 are thus supported by the support member 21 such that the inertia rings 40 can rotate about the center of rotation RC of the support member 21. As described above, the two inertia rings 40 are rotatably coupled to the center plates 31 of the plurality of mass bodies 30.

As can be seen from FIG. 1, when the operation of releasing the lockup coupling has been performed by the lockup clutch 8 in the starting device 1 including the damper device 10 and the vibration damping device 20 described above, torque (power) from the engine EG is transmitted to the input shaft IS of the transmission TM through a path formed by the front cover 3, the pump impeller 4, the turbine runner 5, and the damper hub 7. When the lockup operation has been performed by the lockup clutch 8, torque (power) from the engine EG is transmitted to the input shaft IS of the transmission TM through a path formed by the front cover 3, the lockup clutch 8, the drive member 11, the first springs SP1, the intermediate member 12, the second springs SP2, the driven member 15, and the damper hub 7.

When the lockup operation has been performed by the lockup clutch 8 and the drive member 11 coupled to the front cover 3 by the lockup clutch 8 rotates with rotation of the engine EG, the first and second springs SP1, SP2 act in series between the drive member 11 and the driven member 15 via the intermediate member 12. Torque transmitted from the engine EG to the front cover 3 is thus transmitted to the input shaft IS of the transmission TM, and fluctuation in torque from the engine EG is damped (absorbed) by the first and second springs SP1, SP2 of the damper device 10.

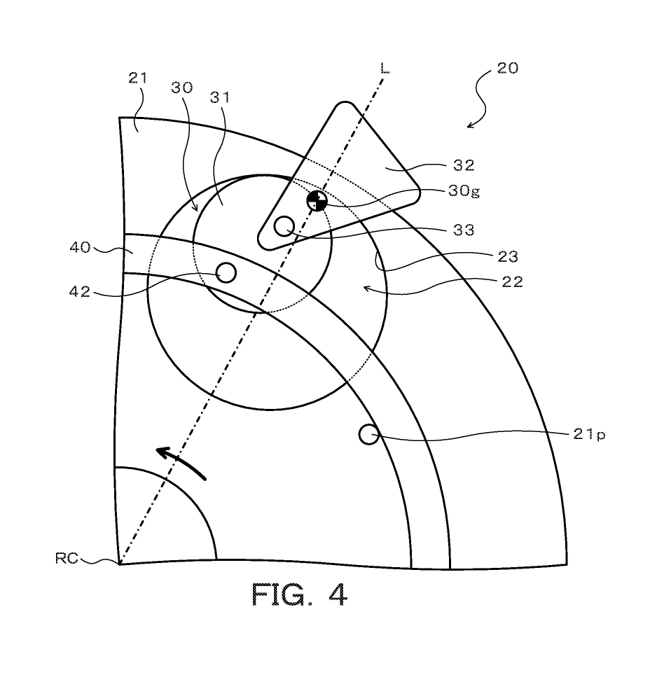

When the lockup operation has been performed by the lockup clutch 8 and the damper device 10 coupled to the front cover 3 by the lockup clutch 8 rotates with the front cover 3, the support member 21 coupled to the intermediate member 12 of the damper device 10 also rotates in the same direction as the front cover 3 about the axis of the starting device 1 (damper device 10). When the rotation of the support member 21 fluctuates, the inertia rings 40 rotate relative to the support member 21 about the center of rotation RC of the support member 21 by the moment of inertia of the inertia rings 40, and the mass bodies 30 roll on the guide surfaces 23 with the center plates 31 of the mass bodies 30 being pressed against the guide surfaces 23 by the centrifugal force. FIG. 4 shows an example of the state of the vibration damping device 20 at this time. In the figure, the thick arrow shows the rotation direction of the support member 21. When the inertia rings 40 rotate relative to the support member 21 and the mass bodies 30 roll on the guide surfaces 23 (when the vibration damping device 20 is no longer in equilibrium), the centrifugal force acting on the mass bodies 30 generates a force (restoring force) in such a direction that the mass bodies 30 are returned to the positions where the mass bodies 30 are located when the vibration damping device 20 is in equilibrium (the position in FIG. 2). The mass bodies 30 and the inertia rings 40 therefore attempt to return to the positions where the mass bodies 30 and the inertia rings 40 are located when the vibration damping device 20 is in equilibrium. The inertia rings 40 thus swing relative to the support member 21, and the mass bodies 30 (center plates 31) swing relative to the support member 21 while rolling on the guide surfaces 23. By setting the mass, inertia, and geometric parameters so that the natural frequency of a secondary system formed by the mass bodies 30 and the inertia rings 40 synchronizes with an exciting force, vibration in antiphase from that transmitted from the engine EG to the drive member 11 is applied from the mass bodies 30 and the inertia rings 40 to the support member 21, whereby vibration of the support member 21 and thus of the intermediate member 12 and the driven member 15 can be absorbed (damped).

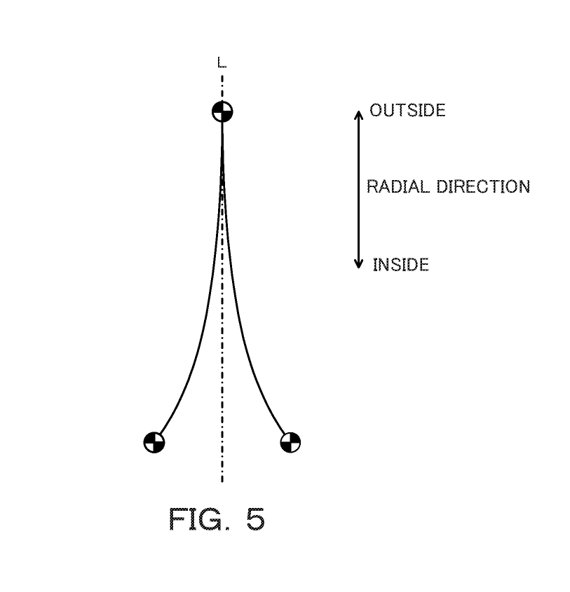

FIG. 5 is an illustration showing an example of a trajectory that is followed by the center of gravity 30g of the mass body 30 when the inertia rings 40 swing relative to the support member 21 about the center of rotation RC of the support member 21 and the center plate 31 of the mass body 30 rolls on the guide surface 23. In the vibration damping device 20 of FIG. 2, since the shape (shape as viewed in the axial shape) of the guide surface 23 and the shape (shape as viewed in the axial direction) of a rolling surface formed on the outer periphery of the center plate 31 are a circle (circular arc) or an ellipse (elliptical arc) and the center of curvature of the circular arc or elliptical arc of the guide surface 23 is located radially outward of the center of rotation RC, the trajectory of the center of gravity 30g of the mass body 30 has an inverted curved V-shape as shown in FIG. 5. On the other hand, in the case where both the shape (shape as viewed in the axial shape) of the guide surface 23 and the shape (shape as viewed in the axial direction) of the rolling surface formed on the outer periphery of the center plate 31 are a circle and the center of curvature of the circular arc of the guide surface 23 matches the center of rotation RC, the trajectory of the center of gravity 30g of the mass body 30 is a hypocycloid (internal cycloid) if the center of gravity 30g of the mass body 30 at an equilibrium position is located on the guide surface 23, the trajectory of the center of gravity 30g of the mass body 30 is a hypotrochoid if the center of gravity 30g of the mass body 30 at the equilibrium position is located radially outward of the guide surface 23, and the trajectory of the center of gravity 30g of the mass body 30 is also a hypotrochoid if the center of gravity 30g of the mass body 30 at the equilibrium position is located radially inward of the guide surface 23. The trajectory of the center of gravity 30g of the mass body 30 is symmetric with respect to the reference line L regardless of whether the trajectory of the center of gravity 30g of the mass body 30 has an inverted curved V-shape, a hypocycloid, or a hypotrochoid. In any case, the closer the center of gravity 30g of the mass body 30 is to the guide surface 23, the less the offset of the center of gravity 30g with respect to the reference line L increases or decreases with radial movement of the center of gravity 30g. The farther the center of gravity 30g is from the guide surface 23, the more the offset of the center of gravity 30g with respect to the reference line L increases or decreases with radial movement of the center of gravity 30g.

In the vibration damping device 20, since the mass body 30 thus rolls on the guide surface 23 while the center plate 31 of the mass body 30 is being pressed against the guide surface 23 by the centrifugal force, the path of the center of gravity 30g of the mass body 30 is continuous (the mass body 30 does not become free and the center of gravity 30g of the mass body 30 therefore does not suddenly move in the circumferential direction of the support member 21). This improves the vibration damping capability of the vibration damping device 20. Moreover, since the center of gravity of the mass body 30 matches the outermost positon of the center plate 31 in the radial direction (the contact position between the center plate 31 and the guide surface 23) when the vibration damping device 20 is in equilibrium, the center of gravity 30g of the mass body 30 is further restrained from moving (swinging) in the circumferential direction of the rotary element when the mass body 30 rolls on the guide surface 23. Moreover, since the guide surface 23 has a circular arc shape or an elliptical shape and the center plate 31 of the mass body 30 has a circular shape or an elliptical shape, the mass body 30 is allowed to more smoothly roll on the guide surface 23.

In the above vibration damping device 20, the center of gravity 30g of the mass body 30 matches the outermost positon of the center plate 31 in the radial direction (the contact position between the center plate 31 and the guide surface 23) when the vibration damping device 20 is in equilibrium. However, the center of gravity 30g of the mass body 30 need not necessarily match the outermost positon of the center plate 31 in the radial direction as long as the center of gravity 30g of the mass body 30 is located radially outward of the position of the rivet 42 (the position of the turning pair formed by the center plate 31 of the mass body 30 and the inertia rings 40) and located on the reference line L.

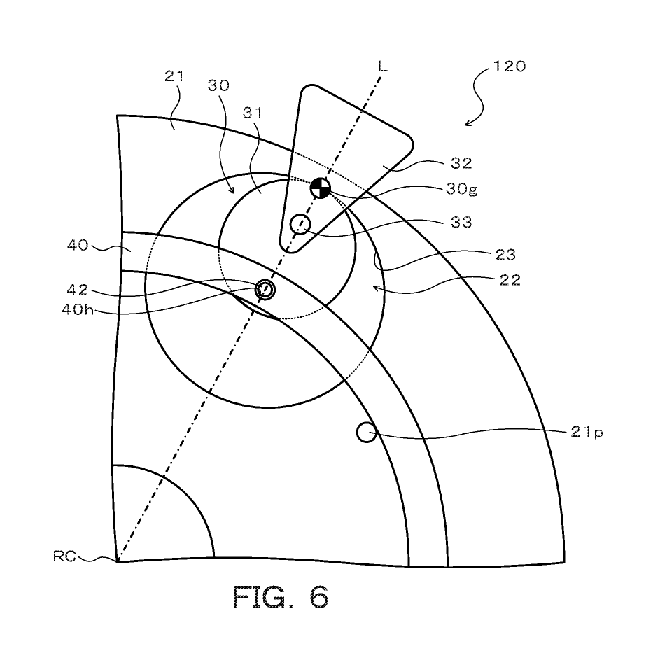

In the above vibration damping device 20, the center plate 31 of the mass body 30 and the inertia rings 40 are coupled via the rivet 42. However, in this coupling, as shown in a vibration damping device 120 of FIG. 6, the center plate 31 and the rivet 42 may be fixed together and clearance may be provided between the inner peripheries of coupling holes 40h formed in the inertia rings 40 and the outer periphery of the rivet 42. With this configuration, the centrifugal force that is applied to the mass body 30 is restrained from acting on the inertia rings 40 and the center plate 31 of the mass body 30 is more firmly pressed against the guide surface 23 of the support member 21. The center plate 31 is therefore restrained from slipping on the guide surface 23 (the center plate 31 is allowed to more reliably roll on the guide surface 23 without slipping).

In this example, the center plate 31 and the rivet 42 are fixed together and clearance is provided between the inner peripheries of the coupling holes 40h formed in the inertia rings 40 and the outer periphery of the rivet 42. However, the inertia rings 40 and the rivet 42 may be fixed together and clearance may be provided between a coupling hole (not shown) formed in the center plate 31 and the outer periphery of the rivet 42. In this case as well, the centrifugal force that is applied to the mass body 30 is restrained from acting on the inertia rings 40 and the center plate 31 of the mass body 30 is more firmly pressed against the guide surface 23 of the support member 21. The center plate 31 is therefore restrained from slipping on the guide surface 23 (the center plate 31 is allowed to more reliably roll on the guide surface 23 without slipping).

In the above vibration damping device 20, the center plate 31 of the mass body 30 rolls on the guide surface 23 of the support member 21 while being pressed against the guide surface 23 by the centrifugal force. However, a friction material (not shown) may be bonded to at least one of the guide surface 23 and the center plate 31. This increases the frictional force between the center plate 31 and the guide surface 23 and restrains the center plate 31 from slipping on the guide surface 23 (allows the center plate 31 to more reliably roll on the guide surface 23 without slipping).

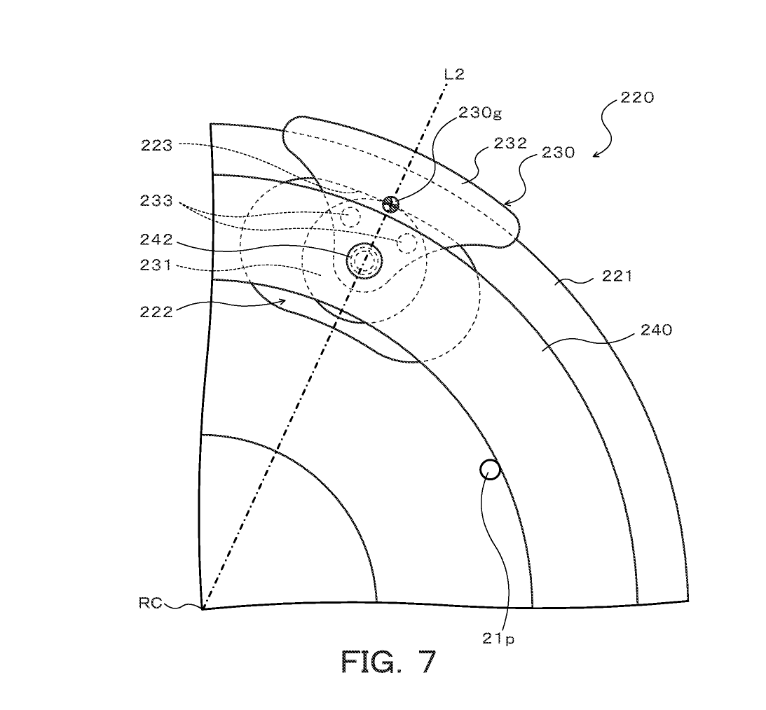

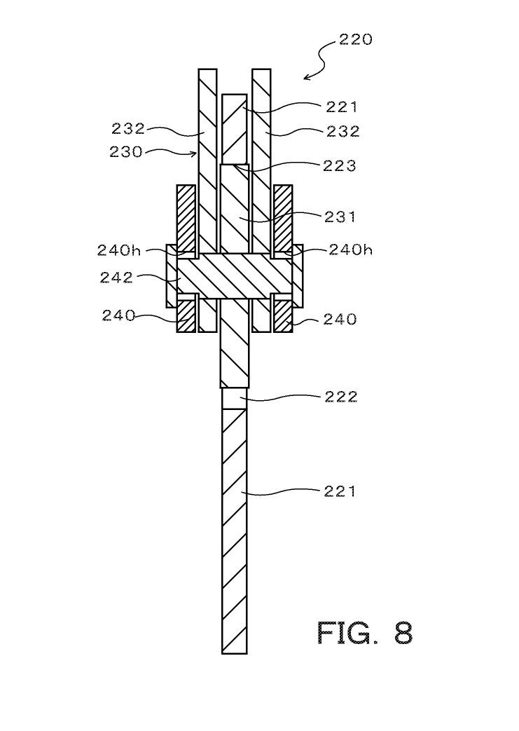

FIGS. 7 and 8 are a front view and a sectional view of still another vibration damping device 220 of the present disclosure. In this vibration damping device 220, a guide hole 222 in a support member 221 is formed so as to extend in the circumferential direction of the support member 221, a guide surface 223 is formed in such a circular arc shape that the center of the circular arc matches the center of rotation RC, a center plate 31 of a mass body 30 is formed in a circular shape, and two side plates 232 of the mass body 230 are formed so as to be shorter in the radial direction of the support member 221 and longer in the circumferential direction of the support member 221 as compared to the two side plates 32 of the mass body 30 of the vibration damping device 20. The center plate 231 and the two side plates 232 are coupled via rivets 233 and a rivet 242 such that, when the vibration damping device 220 is in equilibrium, the center plate 231 and the two side plates 232 are symmetric with respect to a reference line L2 and the center of gravity 230g of the mass body 230 matches the outermost position of the center plate 231 in the radial direction (the contact position between the center plate 231 and the guide surface 223). This configuration allows the center of gravity 30g of the mass body 30 to match the outermost position of the center plate 31 in the radial direction (the contact position between the center plate 31 and the guide surface 23) while making the outside diameter of the vibration damping device 220 smaller than that of the vibration damping device 20. In this case, the trajectory of the center of gravity 230g of the mass body 230 is a hypocycloid (internal cycloid).

In the vibration damping device 220, the mass body 230 (the center plate 231 and the two side plates 232) and the rivet 242 are fixed together and clearance is provided between coupling holes 240h formed in inertia rings 240 and the outer periphery of the rivet 242. Accordingly, the centrifugal force that is applied to the mass body 230 is restrained from acting on the inertia rings 240, and the mass body 230 is more firmly pressed against the guide surface 223 of the support member 221. The center plate 231 is therefore restrained from slipping on the guide surface 231 (the center plate 231 is allowed to more reliably roll on the guide surface 223 without slipping). Alternatively, the inertia rings 240 and the rivet 242 may be fixed together and clearance may be provided between coupling holes (not shown) formed in the center plate 231 and the two side plates 232 and the outer periphery of the rivet 242.

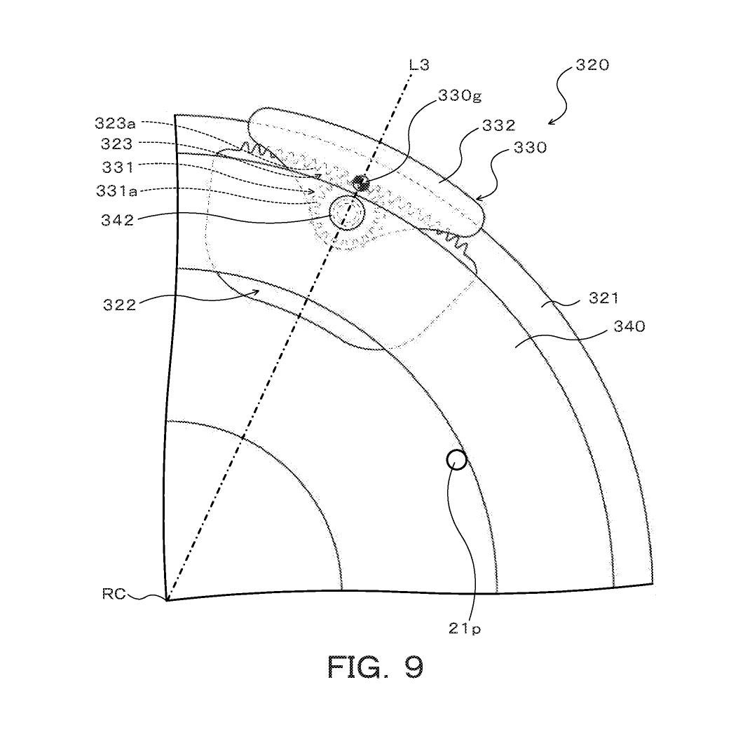

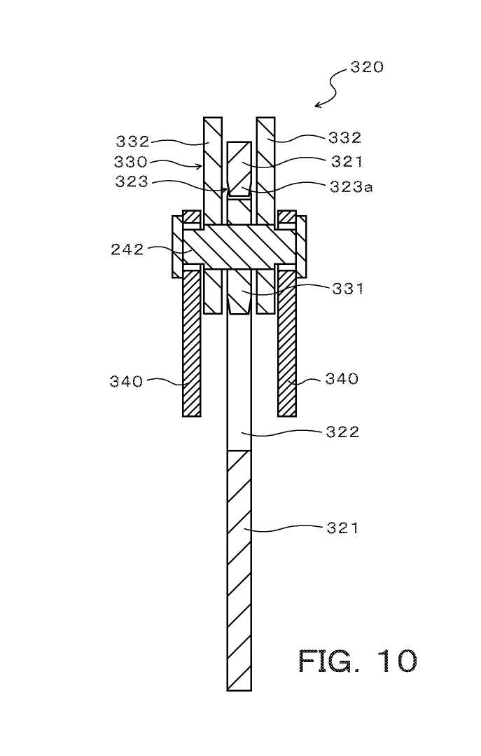

FIGS. 9 and 10 are a front view and a sectional view of a further vibration damping device 320 of the present disclosure. In this vibration damping device 320, as in the vibration damping device 220, a guide hole 322 in a support member 321 is formed so as to extend in the circumferential direction of the support member 321, a guide surface 323 is formed in such a circular arc shape that the center of the circular arc matches the center of rotation RC, a center plate 331 of a mass body 330 is formed in a circular shape, and two side plates 332 of the mass body 330 are formed so as to be shorter in the radial direction of the support member 321 and longer in the circumferential direction of the support member 321 as compared to the two side plates 32 of the mass body 30 of the vibration damping device 20. The center plate 331 and the two side plates 332 are coupled via a rivet 342 such that, when the vibration damping device 320 is in equilibrium, the center plate 331 and the two side plates 332 are symmetric with respect to a reference line L3 and the center of gravity 330g of the mass body 330 matches the outermost position of the center plate 331 in the radial direction (the contact position between the center plate 331 and the guide surface 323). The mass body 330 (the center plate 331 and the two side plates 332) and the rivet 342 are fixed together and clearance is provided between coupling holes formed in inertia rings 340 and the outer periphery of the rivet 342. Alternatively, the inertia rings 340 and the rivet 342 may be fixed together and clearance may be provided between coupling holes (not shown) formed in the center plate 331 and the two side plates 332 and the outer periphery of the rivet 342.

In the vibration damping device 320, unlike the vibration damping devices 20, 120, 220, the guide surface 323 has a plurality of internal teeth (first gear teeth) 323a, and the center plate 331 of the mass body 330 has a plurality of external teeth (second gear teeth) 331a, so that the center plate 331 rolls on the guide surface 323 as the external teeth 331a of the center plate 331 mesh with the internal teeth 323a of the guide surface 323. The center plate 331 is therefore restrained from slipping on the guide surface 323 (the center plate 331 is allowed to more reliably roll on the guide surface 323 without slipping). The vibration damping capability is thus more reliably improved.

In the above vibration damping device 20, the center plate 31 of the mass body 30 is formed in a circular shape or an elliptical shape. However, the center plate 31 of the mass body 30 may have a cut-away circular or elliptical shape, namely a shape formed by cutting away a part of the circular or elliptical center plate 31 which does not contact the guide surface 23 of the support member 21.

The above vibration damping device 20 is coupled to the intermediate member 12 of the damper device 10. However, as shown by the long dashed double-short dashed lines in FIG. 1, the vibration damping device 20 may be coupled to either the drive member 11 or the driven member 15.

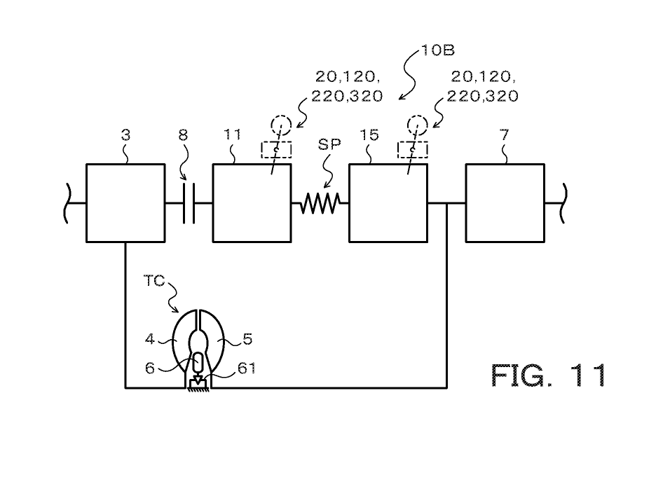

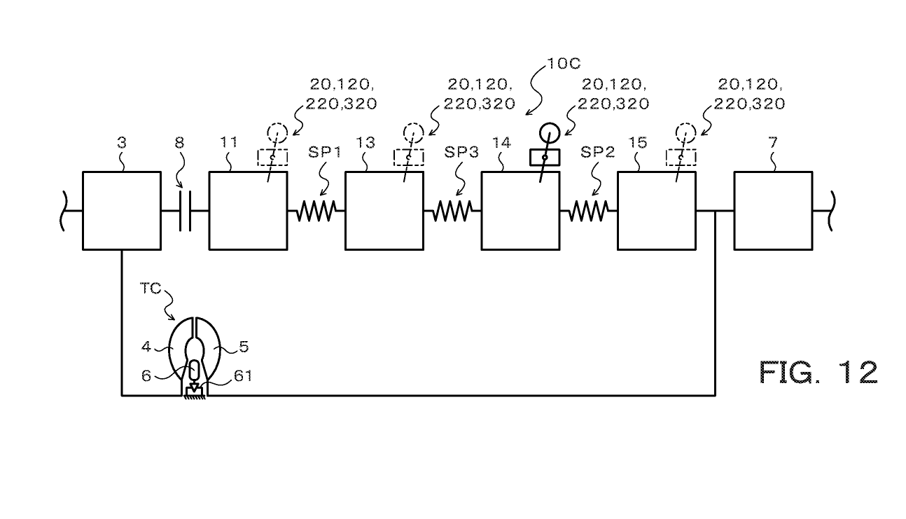

The vibration damping devices 20, 120, 220, 320 may be applied to a damper device 10B of FIG. 11. The damper device 10B of FIG. 6 corresponds to the above damper device 10 from which the intermediate member 12 is omitted. The damper device 10B includes, as rotary elements, the drive member (input element) 11 and the driven member (output element) 15 and includes, as torque transmission elements, springs SP disposed between the drive member 11 and the driven member 15. In this case, the vibration damping devices 20, 120, 220, 320 may be coupled to the driven member 15 as shown in the figure (shown by the solid lines) or may be coupled to the drive member 11 as shown by the long dashed double-short dashed lines in the figure.

The vibration damping devices 20, 120, 220, 320 may be applied to a damper device 10C of FIG. 12. The damper device 10C of FIG. 7 includes, as rotary elements, the drive member (input element) 11, a first intermediate member (first intermediate element) 13, a second intermediate member (second intermediate element) 14, and the driven member (output element) 15 and includes, as torque transmission elements, first springs SP1 disposed between the drive member 11 and the first intermediate member 13, second springs SP2 disposed between the second intermediate member 14 and the driven member 15, and third springs SP3 disposed between the first intermediate member 13 and the second intermediate member 14. In this case, the vibration damping devices 20, 120, 220, 320 may be coupled to the second intermediate member 14 as shown in the figure (shown by the solid lines) or may be coupled to any of the drive member 11, the first intermediate member 13, and the driven member 15 as shown by the long dashed double-short dashed lines in the figure.

As described above, the vibration damping device of the present disclosure is a vibration damping device (20, 120, 220, 320) that damps vibration of a rotary element (21, 221, 321) to which torque from an engine (EG) is transmitted. The vibration damping device (20, 120, 220, 320) includes: a guide surface (23, 223, 323) formed in the rotary element (21, 221, 321); a mass body (30, 230, 330) that, as the rotary element (21, 221, 321) rotates, rolls on the guide surface (23, 223, 323) while being pressed against the guide surface (23, 223, 323) by a centrifugal force; and an annular member (40, 240, 340) that is rotatably coupled to the mass body (30, 230, 330) and swings about a center of rotation of the rotary element (21, 221, 321). When the vibration damping device (20, 120, 220, 320) is in equilibrium, a center of gravity of the mass body (30, 230, 330) is located radially outward of a joint position between the mass body (30, 230, 330) and the annular member (40, 240, 340).

This vibration damping device of the present disclosure includes: the guide surface formed in the rotary element to which torque from the engine is transmitted; the mass body that, as the rotary element rotates, rolls on the guide surface while being pressed against the guide surface by the centrifugal force; and the annular member that is rotatably coupled to the mass body and swings about the center of rotation of the rotary element. When the vibration damping device is in equilibrium, the center of gravity of the mass body is located radially outward of the joint position between the mass body and the annular member. Accordingly, when the rotation of the rotary element fluctuates, the annular member rotates relative to the rotary element about the center of rotation of the rotary element by the moment of inertia of the annular member, and the mass body rolls on the guide surface while being pressed against the guide surface by the centrifugal force. Each of the mass body and the annular member thus swings relative to the rotary element. At this time, the center of gravity of the mass body moves radially inward (in the radial direction or substantially in the radial direction) with respect to the position where the center of gravity of the mass body is located when the vibration damping device in equilibrium. Accordingly, (a component of) the centrifugal force acting on the mass body generates such a restoring force that returns the annular member toward the position where the annular member is located when the vibration damping device is in equilibrium. In such a device, the natural frequency of the secondary system which increases with the number of revolutions and which is determined by the mass of the mass body, the moment of inertia of the annular member, and geometric parameters for the mass body and the rotary element can be matched with the frequency of fluctuation in torque which is applied to the rotary element. As a result, vibration in antiphase from that of the rotary element is applied from the annular member and the mass body to the rotary element, whereby the vibration of the rotary element can be damped. Moreover, since the mass body rolls on the guide surface while being pressed against the guide surface by the centrifugal force, a path of the center of gravity of the mass body is continuous in the circumferential direction (the mass body does not become free and the center of gravity of the mass body therefore does not suddenly move in the circumferential direction of the rotary element). As a result, the vibration damping capability of the vibration damping device is improved.

In such a vibration damping device of the present disclosure, when the vibration damping device (20, 120, 220, 320) is in equilibrium, the center of gravity of the mass body (30, 230, 330) may be located on a straight line passing through the center of rotation of the rotary element (21, 221, 321) and the joint position between the mass body (30, 230, 330) and the annular member (40, 240, 340). This allows the mass body to roll symmetrically with respect to this straight line when rolling on the guide surface. In this case, when the vibration damping device (20, 120, 220, 320) is in equilibrium, the center of gravity of the mass body (30, 230, 330) may match a contact position between the mass body (30, 230, 330) and the guide surface (23, 223, 323). This further restrains the center of gravity of the mass body from moving (swinging) in the circumferential direction of the rotary element when the mass body rolls on the guide surface.

In the vibration damping device of the present disclosure, the mass body (30, 230, 330) and the annular member (40, 240, 340) may be coupled via a coupling shaft (42, 242, 342), one of the mass body (30, 230, 330) and the annular member (40, 240, 340) may be fixed to the coupling shaft (42, 242, 342), and clearance may be provided between the other of the mass body (30, 230, 330) and the annular member (40, 240, 340) and the coupling shaft (42, 242, 342). This restrains the centrifugal force that is applied to the mass body from acting on the annular member and thus restrains the mass body from slipping on the guide surface.

In the vibration damping device of the present disclosure, the guide surface (23, 223, 323) may be a concave surface that curves toward an outer periphery of the rotary element (21, 221, 321).

In the vibration damping device of the present disclosure, the guide surface (23, 223, 323) may be formed in a circular arc shape or an elliptical arc shape, and the mass body (30, 230, 330) may be formed in a circular shape or an elliptical shape. This allows the mass body to more smoothly roll on the guide surface.

In the vibration damping device of the present disclosure, at least one of the guide surface (23) and the mass body (30) may have a friction material bonded thereto. This restrains the mass body from slipping on the guide surface (allows the mass body to more reliably roll on the guide surface without slipping).

In the vibration damping device of the present disclosure, the guide surface (323) may have a plurality of first gear teeth (323a), the mass body (330) may have a plurality of second gear teeth (331a), and the mass body (330) may roll on the guide surface (323) as the second gear teeth (331a) of the mass body (330) mesh with the first gear teeth (323a) of the guide surface (323). This restrains the mass body from slipping on the guide surface (allows the mass body to more reliably roll on the guide surface without slipping).

It should be understood that, although the modes for carrying out the present disclosure are described above, the present disclosure is not limited in any way to such embodiments and can be carried out in various forms without departing from the spirit and scope of the present disclosure.

### INDUSTRIAL APPLICABILITY

The present disclosure is applicable to the manufacturing industry of vibration damping devices, etc.

1. A vibration damping device that damps vibration of a rotary element to which torque from an engine is transmitted, comprising:
a guide surface formed in the rotary element;
a mass body that, as the rotary element rotates, rolls on the guide surface while being pressed against the guide surface by a centrifugal force; and
an annular member that is rotatably coupled to the mass body and swings about a center of rotation of the rotary element, wherein
when the vibration damping device is in equilibrium, a center of gravity of the mass body is located radially outward of a joint position between the mass body and the annular member.

2. The vibration damping device according to claim 1, wherein
when the vibration damping device is in equilibrium, the center of gravity of the mass body is located on a straight line passing through the center of rotation of the rotary element and the joint position between the mass body and the annular member.

3. The vibration damping device according to claim 2, wherein
when the vibration damping device is in equilibrium, the center of gravity of the mass body matches a contact position between the mass body and the guide surface.

4. The vibration damping device according to claim 1, wherein
the mass body and the annular member are coupled via a coupling shaft,
one of the mass body and the annular member is fixed to the coupling shaft, and
clearance is provided between the other of the mass body and the annular member and the coupling shaft.

5. The vibration damping device according to claim 1, wherein
the guide surface is a concave surface that curves toward an outer periphery of the rotary element.

6. The vibration damping device according to claim 1, wherein
the guide surface is formed in a circular arc shape or an elliptical arc shape, and
the mass body is formed in a circular shape or an elliptical shape.

7. The vibration damping device according to claim 1, wherein
at least one of the guide surface and the mass body has a friction material bonded thereto.

8. The vibration damping device according to claim 1, wherein
the guide surface has a plurality of first gear teeth,
the mass body has a plurality of second gear teeth, and
the mass body rolls on the guide surface as the second gear teeth of the mass body mesh with the first gear teeth of the guide surface.

9. The vibration damping device according to claim 2, wherein
the mass body and the annular member are coupled via a coupling shaft,
one of the mass body and the annular member is fixed to the coupling shaft, and
clearance is provided between the other of the mass body and the annular member and the coupling shaft.

10. The vibration damping device according to claim 2, wherein
the guide surface is a concave surface that curves toward an outer periphery of the rotary element.

11. The vibration damping device according to claim 2, wherein
the guide surface is formed in a circular arc shape or an elliptical arc shape, and
the mass body is formed in a circular shape or an elliptical shape.

12. The vibration damping device according to claim 2, wherein
at least one of the guide surface and the mass body has a friction material bonded thereto.

13. The vibration damping device according to claim 2, wherein
the guide surface has a plurality of first gear teeth,
the mass body has a plurality of second gear teeth, and
the mass body rolls on the guide surface as the second gear teeth of the mass body mesh with the first gear teeth of the guide surface.

14. The vibration damping device according to claim 3, wherein
the mass body and the annular member are coupled via a coupling shaft,
one of the mass body and the annular member is fixed to the coupling shaft, and
clearance is provided between the other of the mass body and the annular member and the coupling shaft.

15. The vibration damping device according to claim 3, wherein
the guide surface is a concave surface that curves toward an outer periphery of the rotary element.

16. The vibration damping device according to claim 3, wherein
the guide surface is formed in a circular arc shape or an elliptical arc shape, and
the mass body is formed in a circular shape or an elliptical shape.

17. The vibration damping device according to claim 3, wherein
at least one of the guide surface and the mass body has a friction material bonded thereto.

18. The vibration damping device according to claim 3, wherein
the guide surface has a plurality of first gear teeth,
the mass body has a plurality of second gear teeth, and
the mass body rolls on the guide surface as the second gear teeth of the mass body mesh with the first gear teeth of the guide surface.

19. The vibration damping device according to claim 4, wherein
the guide surface is a concave surface that curves toward an outer periphery of the rotary element.

20. The vibration damping device according to claim 4, wherein
the guide surface is formed in a circular arc shape or an elliptical arc shape, and
the mass body is formed in a circular shape or an elliptical shape.
